(19) United States
(12) Patent Application Publication
(10) Pub. No.: US 2025/0330099 A1
(43) Pub. Date: Oct. 23, 2025

(54) Actuating a Power-Electronics DC-DC Converter

(71) Applicant: BAYERISCHE MOTOREN WERKE AKTIENGESELLSCHAFT, München (DE)

(72) Inventors: Martin BAUMANN, Muenchen (DE); Bert HAJ ALI, Muenchen (DE); Christoph WEISSINGER, Schliersee (DE)

(21) Appl. No.: 18/992,744

(22) PCT Filed: Jun. 28, 2023
(86) PCT No.: PCT/EP2023/067579

§ 371 Date: Jan. 9, 2025

(30) Foreign Application Priority Data
Jul. 26, 2022 (DE) 10 2022 118 712.8

(51) Int. Cl. H02M 3/335; B60L 53/20; H02M 1/00; H02M 1/38

(52) U.S. Cl. CPC H02M 3/33573; B60L 53/20; H02M 1/0012; H02M 1/0043; H02M 1/385; B60L 2210/10

(57) ABSTRACT

A method for actuating a power-electronics DC-DC converter that is operated by a controller and has a primary side with at least two electronic switches and a secondary side, galvanically isolated therefrom, with at least one electronic switch, wherein in the method, a reference variable and/or control parameters for the controller is/are adjusted by a BWHH algorithm. Also disclosed are a controller for controlling a power-electronics DC-DC converter that is configured to carry out the method.

### BACKGROUND AND SUMMARY

The present disclosure relates to a method for actuating a power-electronics DC voltage converter that is operated by a controller, having a primary side with at least two electronic switches and a secondary side, which is galvanically isolated therefrom, with at least one electronic switch wherein, according to the method, an adjustment of a reference variable and/or an adjustment of control parameters for the controller is/are executed. The present disclosure further relates to a controller for controlling a power-electronics DC voltage converter having a primary side with at least two electronic switches and a secondary side, which is galvanically isolated therefrom, with at least one electronic switch, wherein the controller is designed for executing the method. The present disclosure further relates to a vehicle comprising at least one power-electronics DC voltage converter having a primary side with at least two electronic switches and a secondary side, which is galvanically isolated therefrom, with at least one electronic switch, wherein the DC voltage converter is actuatable by the method. The present disclosure is particularly advantageously applicable to electric vehicles, such as hybrid vehicles and, in particular, to fully electrically powered vehicles.

For automated driving functions in vehicles, in particular electric vehicles, a reliable power supply for safety-related components such as, for example, steering and braking systems, is required in the on-board electrical energy system. Resulting safety requirements for the energy supply correspond to the associated Automotive Safety Integrity Levels (ASIL). For the demonstration of functional safety in an early development phase, on-board electrical energy system simulations are executed at system level, in order to ensure a secure energy supply for safety-related components, even in the event of a malfunction. In order to permit the management of a digital simulation of the entire on-board electrical energy system simulation model within an acceptable simulation time, it is intended that simulation models should be resolvable in the most computationally efficient manner possible. In particular, DC voltage converters with power-electronics semiconductor switches, on the grounds of their high-frequency actuation, dictate very stringent requirements for simulation.

For the computationally efficient modelling of switched DC voltage converters, “average models” are known, and are available in the literature, for example from: M. Winter,

J. Taube, S. Moser, S. Schoenewolf, H.-G. Herzog: “Average Model of a Synchronous Half-bridge DC/DC Converter Considering Losses and Dynamics”, the 11th International Modelica Conference, 2015; M. Modabbernia: “An Improved State Space Average Model of Buck DC-DC Converter with all of the System Uncertainties”, International Journal on Electrical Engineering and Informatics, March 2013, Vol. 5, pp 81 to 94, and L. Cao: “Small Signal Modeling for Phase-shifted PWM Converters with a Current Double Rectifier”, IEEE Power Electronics Specialists Conference, 2007, pp 423 to 429. These average models represent the average value, rather than the entire switching process.

Martin Baumann, Bert Haj Ali, Christoph Weissinger, Hans-Georg Herzog: “Efficient Small-Signal Algorithm for High Dynamic Phase-Shifted Full-Bridge Converters”, Vehicle Power and Propulsion Conference, Gijón, Spain, November 2020, discloses an algorithm which is capable of efficiently replicating the dynamic response of a phase-shifted full-bridge converter by the iterative calculation of diode conduction times and corresponding state-space systems. A proposed converter module incorporates an additional voltage source, which represents the dynamic response of the converter for various load-dependent dead time behaviors. The additional voltage is calculated on the basis of the predicted leakage current during a switching cycle. In comparison with a switched model, the algorithm reduces computing time by 91%. The publication of Baumann et al. is incorporated by reference in its entirety in the present disclosure.

An object of the present disclosure is to at least partially overcome the disadvantages of the prior art and, in particular, to provide a more reliable design of a power supply, in particular for safety-related components in vehicles.

This object is fulfilled according to the features disclosed herein. Preferred embodiments, in particular, can also be inferred from the present disclosure.

This object is fulfilled by a method for actuating a power-electronics DC voltage converter that is operated by a controller, having a primary side with at least two electronic switches and a secondary side, which is galvanically isolated therefrom, with at least one electronic switch wherein, according to the method, an adjustment of a reference variable and/or an adjustment of control parameters for the controller is/are executed by a BWHH algorithm.

This method provides an advantage in that, by the employment of the BWHH algorithm, inaccuracies in available average models can be substantially reduced. A substantial economization of computing time can be maintained. In turn, by the adjustment of the reference variable of the controller and/or of control parameters, a more efficient operation of a power- electronics DC voltage converter is enabled.

In particular, a power-electronics DC voltage converter is understood as a DC voltage converter which is also capable of converting large electrical capacities and which, to this end, in particular, employs power semiconductors, e.g. power MOSFETs and IGBTs as electronic switches.

According to a further development, the at least two electronic switches on the primary side are components of a bridge circuit, e.g. a half-bridge having two electronic switches, or a full-bridge having four electronic switches. However, the number of electronic switches on the primary side is not limited and, depending upon circuit topology, can also comprise three, or more than four electronic switches.

Galvanic isolation can be achieved, for example, by a transformer which is equipped with at least one primary coil and at least one secondary coil.

The at least one electronic switch on the secondary side, in particular, is designed to rectify the electric voltage which is induced on the secondary side transformer half- unit.

According to a particularly advantageous configuration, the DC voltage converter comprises a primary side having a full-bridge with four electronic switches and a secondary side with two electronic switches, wherein the primary side and the secondary side are galvanically isolated from one another by a transformer. According to one configuration, the DC voltage converter is a phase-shifted full-bridge, as this operates in a particularly efficient manner, and is flexibly adjustable.

The electronic switches can be e.g. power semiconductors, for example power transistors e.g. power MOSFETs and IGBTs, but also e.g. power diodes, etc.

Depending upon circuit topology, the DC voltage converter can be configured as a step-up converter, a step-down converter, or a combination thereof.

The “BWHH algorithm” is an algorithm which employs the method described, in a general manner, in Martin Baumann, et. al: “Efficient Small-Signal Algorithm for High-Dynamic Phase-Shifted Full-Bridge Converters”, in particular in chapter III, for a phase-shifted full-bridge (PSFB), in order to calculate a duty cycle loss dL and/or an additional voltage uadd by the prediction of a current iLk associated with a primary side stray inductance Lk, and is named after the authors. However, the BWHH algorithm which is described in detail in Baumann et al., with reference to the phase-shifted full-bridge which is represented therein in FIG. 1, provided that a switching scheme is known, can also be transposed to other DC voltage converter topologies. Additionally, the BWHH algorithm can thus be adapted to other DC voltage converters having a primary side half-bridge, exclusively step-up or step-down converters, etc.

The duty cycle loss is calculated, in particular, for step-down conversion, and the additional voltage, in particular, for step-up conversion. A duty cycle loss for step-up conversion, if required, can be calculated, or at least estimated from the additional voltage.

According to a further development, the reference variable is calculated as a function of the duty cycle loss dL and/or of the additional voltage uadd. The reference variable can also be described as a control reference.

In particular, the execution of an adaptation of control parameters of the controller by the BWHH algorithm comprises the execution of the adaptation of control parameters by reference to the output variable(s) of the BWHH algorithm, namely, the duty cycle loss dL and/or the additional voltage uadd. Control parameters can be, for example, customary parameters for a regulating controller, e.g. for a PI controller the variables Kp and Ki, and for a PID controller the variables Kp, Ki and Kd. In principle, the type of controller for which an adjustment of control parameters can be adjusted by the BWHH algorithm is not limited. The adjustment of control parameters, in particular, can be executed with the objective of achieving an advantageous dynamic control response (e.g. a short transient recovery time and/or a small overshoot amplitude).

According to one configuration, the DC voltage converter is controlled by a cascaded current-voltage controller. In this case, adjustable control parameters, in particular, can be control parameters of a current controller and/or of a voltage controller for current-voltage control.

According to one configuration, the BWHH algorithm calculates a duty cycle loss and/or an additional voltage from the following input variables: the input voltage applied to the primary side of the DC voltage controller, the duty cycle output (e.g. of a current controller for current-voltage control), the output voltage delivered at the secondary side of the DC voltage converter and the output current at the secondary side of the DC voltage converter.

According to one configuration, from the above-mentioned variables, the BWHH algorithm:
firstly calculates a ripple current;
from the ripple current, calculates an initial value for a current ilk in a primary side transformer half-unit, or a corresponding stray inductance;
successively calculates, for each phase of a switching scheme of the DC voltage converter, the current iLk at the end of the relevant phase; and
at the end of the final phase of this switching scheme, calculates the duty cycle loss and/or the additional voltage therefrom.

An advantage is thus achieved, in that the duty cycle loss and/or the additional voltage can be calculated from simple input variables, notwithstanding the highly dynamic quality of system states in the DC voltage converter, which quantitatively describe the individual states of all energy stores (e.g. inductance(s), capacitance(s), etc.) in the system considered, for a specific collective setting of switches. A circuit state of the electronic (primary and secondary side) switches is assigned to each phase, wherein these circuit states, and the sequence thereof, are dictated by the switching scheme. In general, a plurality of system states (typically described as vectors, or vector-like) are assigned to each circuit state. Consequently, the value of the current iLk at the start of a phase differs from the value of the current iLk at the end of the phase. Thus, if the end-of-phase current iLk is calculated for each successive phase of the switching scheme, this means that, commencing from an initial value for the current iLk, a calculation is executed as to how this current behaves within a first phase, or what is the value thereof at the end of the first phase. This value at the end of the first phase is employed as an input value for a subsequent second phase, and the value thereof at the end of the second phase is then calculated, etc.

According to one configuration, the reference variable corresponds to a (reference) time delay, which is calculated as a function of the duty cycle loss dL which is calculated by the BWHH algorithm. The time delay represents a measure of a delayed switching of electronic switches on the secondary side. According to a further development, the calculated (reference) time delay is compared with a measured time delay, and the differential is employed as a control deviation. The control deviation can then be transmitted e.g. to an integrating controller, which calculates a time interval therefrom which, e.g. in a modulator, is employed for generating the switching pattern of the secondary side switches.

The object is further fulfilled by a controller (also described as a control device or control circuit) for controlling a power-electronics DC voltage controller having a primary side with at least two electronic switches, and a secondary side, which is galvanically isolated therefrom, with at least one electronic switch, in particular of the type described above, wherein the controller is designed for executing the above-mentioned method. The controller can be embodied in an analogous manner to the method, and vice versa, and comprises the same advantages.

The controller can thus be a cascaded current-voltage controller. The BWHH algorithm can be implemented in the form of hardware or software. The controller can comprise e.g. a PI or PID current controller and a PI or PID voltage controller, etc.

The object is further fulfilled by a vehicle comprising at least one power-electronics DC voltage converter having a primary side with at least two electronic switches and a secondary side, which is galvanically isolated therefrom, with at least one electronic switch, wherein the DC voltage converter is actuatable by the above-mentioned method. The vehicle can be embodied in an analogous manner to the method and/or to the controller, and vice versa, and comprises the same advantages.

According to one configuration, the DC voltage converter is designed to convert a voltage between two on-board electrical energy sub-systems of the vehicle having different voltage levels. The two on-board electrical energy sub-systems can be, for example, a high-voltage (HV) on-board electrical energy sub-system having a first system voltage, and a low-voltage (LV) on-board electrical energy sub-system having a second system voltage, wherein the first system voltage is greater than the second system voltage. The first system voltage can lie, for example, between 48 V and 800 V, or even higher. The second system voltage can lie, for example, between 12 V and 60 V.

The vehicle can be, for example, a vehicle having a combustion engine or—particularly advantageously—an electric vehicle, such as a hybrid vehicle or a fully electrically powered vehicle. The vehicle can be, for example, a land vehicle such as an automobile, a motorcycle, a bus, a heavy goods vehicle, etc., an aircraft such as an airplane, a helicopter, etc., or a watercraft such as a ship, etc.

The above-mentioned properties, features and advantages of the present disclosure, and the manner in which these are achieved, will be further explained and clarified in conjunction with the following schematic description of one exemplary embodiment, which is described in greater detail with reference to the drawings.

### BRIEF DESCRIPTION OF THE DRAWINGS

FIG. 1 shows a known (“PSFB”) DC voltage converter in the form of a phase-shifted full-bridge;

FIG. 2 shows a sketch of a controller layout for controlling the phase-shifted full-bridge according to FIG. 1;

FIG. 3 shows a potential sequence for calculating a duty cycle loss and an additional voltage by a BWHH algorithm; and

FIG. 4 shows a sub-sequence of the sequence according to FIG. 3.

### DETAILED DESCRIPTION OF THE DRAWINGS

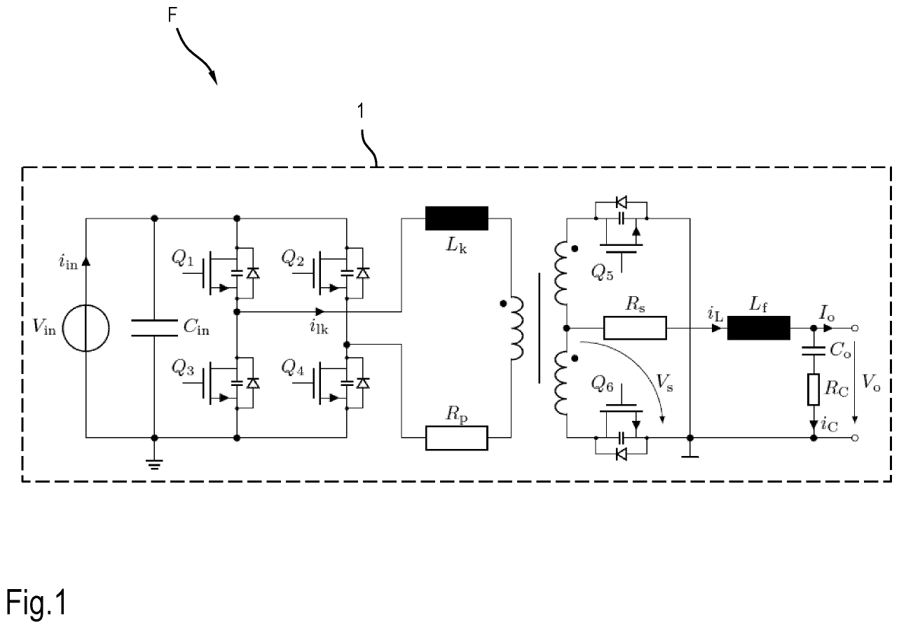

FIG. 1 shows an equivalent circuit diagram of a DC voltage converter in the form of a phase-shifted full-bridge 1, as illustrated in Baumann et al.: “Efficient Small-Signal Algorithm for High Dynamic Phase-Shifted Full-Bridge Converters”, FIG. 1. In particular, this phase-shifted full-bridge 1 can be designed, in a vehicle F, in particular in a fully electrically powered vehicle F, for converting a voltage between two on-board electrical energy sub-systems of the vehicle having different voltage levels, in particular for a step-down transformation of a voltage on a HV on-board electrical energy sub-system into a voltage on a LV on-board electrical energy sub-system or, conversely, for a step-up transformation.

The primary side full-bridge inverter in the form of a four-quadrant controller incorporates electronic switches Qi, where i=1, . . . , 4, which contain both reverse-polarity freewheeling diodes (body diodes) and drain-source capacitors. The full-bridge is connected to a low-inductance planar transformer with a center tap, which dominates the dynamic response associated with the stray inductance Lk of the primary side transformer half-unit. The resistance Rp of the primary side transformer half-unit comprises through-connections and a blocking capacitor resistance. The secondary rectification circuit contains two electronic switches Q5, Q6 and an inductive-capacitive filter. The secondary side inductance Lf exceeds the primary side stray inductance Lk by one order of magnitude. The resistance Rs incorporates the resistances of the transformer, shunt and PCB vias. An output capacitance C0 is modelled, with its associated parasitic resistance Rc.

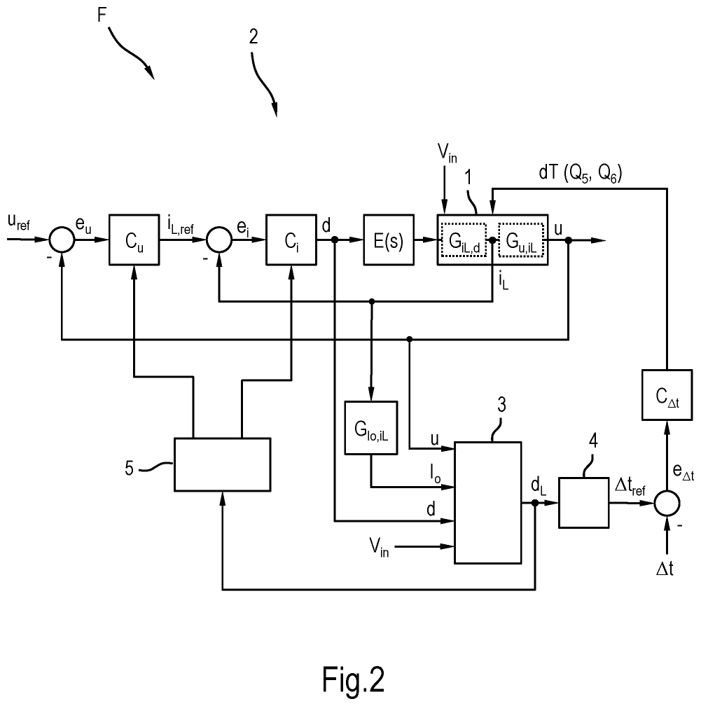

FIG. 2 shows a sketch of a cascaded current-voltage controller layout 2 for controlling the phase-shifted full-bridge 1, or a method for actuating the phase-shifted full-bridge 1 which is operated by the cascaded current-voltage controller layout. The controller layout 2, without limitation of generality, is simply described hereinafter as “the controller” 2.

The controller 2 comprises a voltage controller Cu, e.g. a PI or PID controller, which receives a control deviation eu by way of an input variable. The control deviation eu corresponds to a differential between a target output voltage uref and an actual output voltage u of the phase-shifted full-bridge 1, wherein u corresponds to the output voltage V0 represented in FIG. 1, i.e. u=V0.

The voltage controller Cu outputs a target value iL, ref for the current in a secondary side filter inductance Lf, by way of a manipulated variable. A control deviation ei, which is calculated from the differential between the target value iL, ref and an actual value iL of the current in the filter inductance Lf, is injected as an input variable into a current controller Ci, e.g. a PI or PID controller which, by way of an output signal, transmits a duty cycle d to an actuator E(s). The actuator E(s) reproduces a delay in the duty cycle d, which is associated e.g. with a computing time of a microcontroller. The term “s” represents the associated Laplace variable.

For the purposes of control technology, the phase-shifted full-bridge 1 can be represented as a controlled system having a first transformation unit GiL,d, which calculates the actual current variable iL from the duty cycle d, and a first transformation unit GiL,d, which calculates the actual output voltage u from the actual current variable iL.

The algorithm described in Baumann et al., chapter III, for calculating the duty cycle loss dL and the additional voltage uadd can now be employed for improving a dynamic control response, for example by a more rapid setpoint change response, and/or for enabling a more efficient operation of the phase-shifted full-bridge 1. To this end, in a calculation unit 3, in which the algorithm is implemented, an input of the duty cycle d, the output voltage u=V0, the output current 10 and the input voltage Vin, as input variables, is executed. The output current I0 can be calculated, by a transformation unit GI0,iL, from the actual value iL of current in the filter inductance Lf, or can be measured directly at the output of the phase-shifted full-bridge 1.

As described e.g. in Baumann et al., the calculation unit 3, in step-down conversion, can calculate the duty cycle loss dL and, in step-up conversion and no-load operation, can calculate the additional voltage uadd herefrom. In the present case, the duty cycle loss dL, as indicated by a calculation unit 4, is employed for calculating a (reference/target) time delay Δtref=f(dL), which represents a measure for a delayed switching of the switches Q5 and/or Q6, which proceeds from the calculated duty cycle loss dL.

It is then endeavored to reconcile the actual, e.g. measured time delay At in force with the reference time delay Δtref. To this end, the differential eΔt between the measured time delay Δt and the reference time delay Δtref is determined, and is routed to a controller CΔt as a control deviation. As a manipulated variable, the controller CΔt calculates a switching instant delay dT herefrom for the switches Q5 and/or Q6, which is employed in an (unrepresented) modulator for generating the switching pattern of the switches Q5 and Q6. The controller CΔt, in particular, is an integrating controller, e.g. a PI or PID controller.

Moreover, the duty cycle loss dL—indicated here by an adjustment unit 5—can be employed for adjusting control parameters of the controllers Cu and Ci, e.g. in the case of a PID controller, Kp, Ki and Kd. Control parameters are adjusted to the existing controlled system of the on-board electrical energy system, such that the phase-shifted full-bridge 1 assumes a superior dynamic response. An advantage is thus achieved, in that the controller can operate more rapidly (e.g. with a shorter setting time, reduced overshoot, etc.) and/or more robustly (e.g. with greater stability at critical working points).

Although the controller 2 has been described in greater detail above with reference to a step-down conversion, it can also be employed for a step-up conversion. In a step-up conversion, by the BWHH algorithm, an additional voltage uadd is calculated, rather than the duty cycle loss dL. The additional voltage uadd, e.g., again by the calculation unit 3, can be converted into an equivalent duty cycle loss dL, and the controlled system can then be employed in an analogous manner to the step-down conversion.

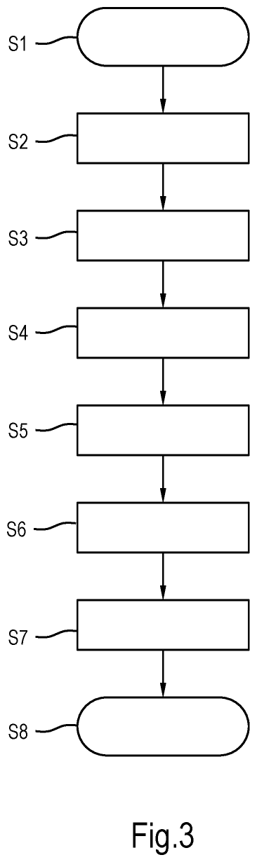

FIG. 3 shows a potential sequence of the BWHH algorithm for a DC voltage converter, the operation of which is divisible into four phases p1, p2, p3 and p4, namely, a first (“power output”) phase p1, a second (“freewheeling”) phase p2, a third (“duty cycle loss”) phase p3, and a fourth (“freewheeling”) phase p4. In particular, the BWHH algorithm can correspond to the algorithm described in Baumann et al., chapter III, but is not limited thereto. The four-phase BWHH algorithm is applicable, for example, to the phase-shifted full-bridge 1. For DC voltage converters with different topologies and/or different switching schemes, fewer or more than four phases can also be provided.

In a step S1, the BWHH algorithm is initialized by an inputting of the input voltage Vin, the output voltage V0, the output current I0 and the duty cycle d.

A ripple current Ir is calculated herefrom in a step S2.

In a step S3, from the ripple current Ir, an initial value for the current ilk in the primary side stray inductance Lk is calculated. This current iLk corresponds to the current in the primary side transformer half-unit.

In a step S4, for the power output phase p1, from the value of the current iLk described in step S3, on the basis of state-space equations which describe the DC voltage converter and potential system states x, a determination is executed of the value of the current iLk in force at the end of the power output phase p1, and of the probable system state x in force at the end of the power output phase p1 from the quantity of potential system states x. A system state x describes a quantity of individual states of all energy stores (e.g. inductance(s), capacitance(s), etc.) in the system considered, in the present case a DC voltage converter, for a specific (switching) position of the switches Q1 to Q6. Exactly one switching position is assigned to one phase, and one phase can comprise a plurality of system states x. The constitution of state-space equations is fundamentally known and, in consequence, will not be described in greater detail here.

Using the current iLk at the end of the power output phase p1 and the calculated system states x at the end of the power output phase p1, a transition to step S5 is executed, in which the (time-variable) current iLk at the end of the freewheeling phase p2 is calculated.

A transition is then executed to a step S6 in which, in an analogous manner to step S4 for the power output phase p1, from the current iLk at the end of the freewheeling phase p2, on the basis of state-space equations and potential system states x, a determination is executed of the current iLk at the end of the duty cycle loss phase p3 and, additionally, of the actual system state x in force at the end of the duty cycle loss phase p3, from the quantity of potential system states x.

Using the current iLk at the end of the duty cycle loss phase p3 and the calculated system states x at the end of the duty cycle loss phase p3, a transition is executed to step S7 in which, in an analogous manner to step S5, the current iLk at the end of the freewheeling phase p4 is calculated.

In a step S8, from the current iLk in force at the end of the freewheeling phase p4, a calculation is then executed of the duty cycle loss dL (in the case of step-down conversion) and/or of the additional voltage uadd (in the case of step-up conversion and in no-load operation).

Although this sequence is described in detail in Baumann at al., with respect to the phase-shifted full-bridge/PSFB DC voltage converter which is represented therein in FIG. 1, provided that the respective switching schemes are known, it can also be translated to other DC voltage converter topologies. These different combinations of a topology and a switching scheme can comprise more or fewer than four phases.

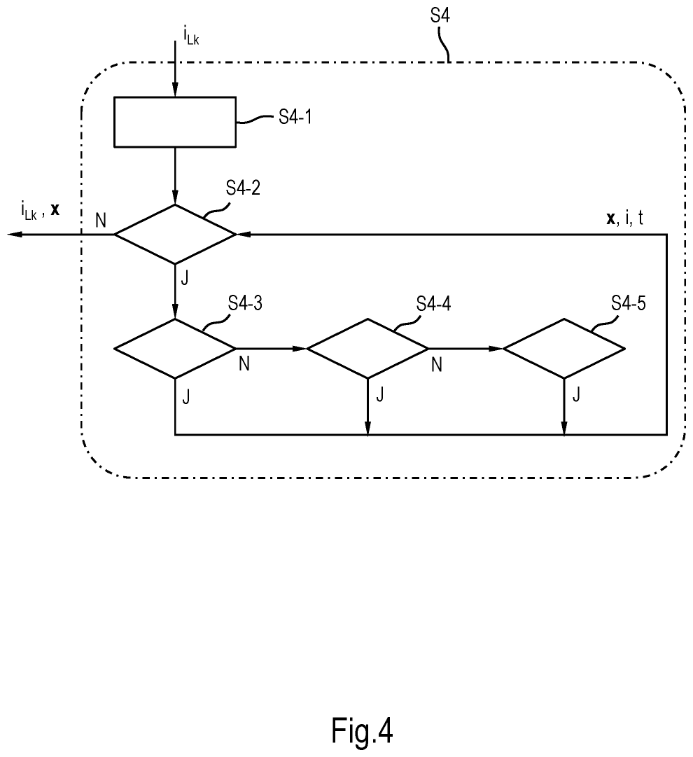

FIG. 4 shows a detailed representation of one example of step S4.

In a first initialization phase S4-1, from the initial value for the current iLk calculated in step S3, an initial system state x (i) is established from the group of potential states x in this phase p1, as the present system state in force with a different value for i. The value t=0 is still in force.

In a step S4-2, a check is executed as to whether the time t elapsed thus far is shorter than a stipulated dead time Td, e.g. of 100 ns, i.e. whether t<Td applies or, alternatively, whether t≤Td applies. This is the case further to step S4-1, wherein t=0, such that a transition to step S4-3 is then executed.

In step S4-3, a check is then executed as to whether a system state x (i) in which e.g. i=0 is in force, in which none of the (body) diodes of the switches Q1 to Q6 is conductive.

If this is the case (“J”), in a step S4-4, for a predefined time slot or time window, the alteration of the system state x is calculated, and a bifurcation to step S4-2 is executed. In step S4-2, a check is executed as to whether the time t, which has now been increased by the time slot, is smaller than, or equal to or smaller than the dead time Td. If this is the case (“J”), a transition to step S4-3 is executed once more.

However, if it is detected, in step S4-3, that a system state x (i) in which i=0 is no longer in force, on the grounds that at least one of the body diodes of the switches Q1 to Q6 is conductive (“N”), a transition is executed to a step S4-5, in which a check is executed as to whether a specific body diode is conducting current, in this case e.g. the body diode of switch Q2.

If this is the case (“J”), in a step S4-6, in an analogous manner to step S4-4, for a predefined time slot or time window, the alteration of the system state x is calculated, and a bifurcation to step S4-2 is then executed. In step S4-2, a check is again executed as to whether the time t, which has now been increased by the time slot, is smaller than, or equal to or smaller than the dead time Td. If this is still the case (“J”), a transition to step S4-3 is again executed.

However, if it proceeds from the check executed in step S4-5 that the body diode of switch Q2 determined therein is not conducting any current (“N”), a transition to step S4-7 is executed. If this step S4-7 corresponds to the most recently available system state x, it must apply that the latter is in force, such that a transition to step S4-8 is then executed in which, in an analogous manner to step 4-4, for a predefined time slot or time window, the alteration of the system state x is calculated and a bifurcation to step S4-2 is then executed. In step S4-2, a check is executed as to whether the time t, which has now been increased by the time slot, is smaller than, or equal to or smaller than the dead time Td. If this is still the case (“J”), a transition to step S4-3 is again executed, etc.

However, if the dead time Td is achieved in step S4-2 (“N”), the present value of the current iLk in force and the present system state x in force are generated as outputs, and are employed as inputs or input variables for step S5.

In the present case, in the first phase p1, only three diode conduction states can be in force, namely, that none of the body diodes is conducting current (i=0), only the body diode of switch Q2 is conductive (i=2), or only the body diode of switch Q4 is conducting current (i=4). In DC voltage converters with different topographies and/or different switching schemes, other system states may be possible.

Naturally, the present disclosure is not limited to the exemplary embodiment illustrated.

In general, the term “a”, “an” etc. can be understood as a singularity or a plurality, particularly within the meaning of “at least one” or “one or more”, etc., provided that this is not explicitly excluded, e.g. by the expression “exactly one”, etc.

Additionally, an indication of number can comprise exactly the number indicated, or can incorporate a customary tolerance margin, provided that this is not explicitly excluded.

### LIST OF REFERENCE SYMBOLS

1 Phase-shifted full-bridge
2 Controller
3 Calculation unit
4 Calculation unit
5 Adjustment unit
Cᵢ Current controller
Cᵤ Voltage controller
C_{Δt} Controller
d Duty cycle
d_{L} Duty cycle loss
E(s) Actuator
eᵢ Control deviation
eᵤ Control deviation
F Vehicle
G_{iL,d} Transformation unit
G_{I0,iL} Transformation unit
G_{u,iL} Transformation unit
i_{L} Actual value of current in secondary side filter inductance
i_{LK} Actual value of current in the stray inductance of the primary side transformer half-unit
i_{L,ref} Target value of current in secondary side filter inductance
I₀ Output current
L_{f} Secondary side filter inductance
Lₖ Stray inductance of primary side transformer half-unit
Qᵢ i^{th} electronic switch
Rₛ Resistance
Rₚ Resistance of primary side transformer half-unit
S1-S7 Process steps
S4-1-S4-5 Sub-steps
t Time
Δt Time delay
Δt_{ref} Target time delay
u Actual output voltage
u_{add} Additional voltage
u_{ref} Target output voltage
Vᵢₙ Input voltage
V₀ Output voltage
x State-space vector

1-11. (canceled)

12. A method for actuating a power-electronics DC voltage converter that is operated by a controller, having a primary side with at least two electronic switches and a secondary side, which is galvanically isolated from the primary side, with at least one electronic switch, the method comprising:
adjusting at least one reference variable and/or control parameters for the controller via a BWHH algorithm.

13. The method according to claim 12,
wherein the DC voltage converter is controlled by a cascaded current-voltage controller, and
wherein the adjustable control parameters comprise control parameters of a current controller and/or control parameters of a voltage controller.

14. The method according to claim 12, comprising:
calculating a duty cycle loss and/or an additional voltage via the BWHH algorithm using the following input variables:
an input voltage at a primary side of the DC voltage controller;
a duty cycle;
an output voltage at the secondary side of the DC voltage converter; and
an output current at the secondary side of the DC voltage converter.

15. The method according to claim 14, comprising:
using the BWHH algorithm and the input variables:
calculating a ripple current;
calculating, from the ripple current, an initial value for a current in a primary side transformer half-unit, or a corresponding stray inductance;
successively calculating, for each phase of a switching scheme of the DC voltage converter, the current; and
at an end of a final phase of the switching scheme, calculating the duty cycle loss and/or the additional voltage therefrom.

16. The method according to claim 12,
wherein the at least one reference variable corresponds to a reference time delay which is calculated as function of a duty cycle loss, which is calculated using the BWHH algorithm, wherein the reference time delay represents a measure of a delayed switching of the at least one electronic switch on the secondary side.

17. The method according to claim 12,
wherein the DC voltage converter comprises a primary side having a full-bridge with four electronic switches and a secondary side with two electronic switches, wherein the primary side and the secondary side are galvanically isolated from one another by a transformer.

18. The method according to claim 17, wherein the DC voltage converter is a phase-shifted full-bridge.

19. A controller for controlling a power-electronics DC voltage converter having a primary side with at least two electronic switches and a secondary side, which is galvanically isolated from the primary side, with at least one electronic switch, wherein the controller is configured to:
adjust at least one reference variable and/or control parameters for the controller via a BWHH algorithm.

20. The controller according to claim 19,
wherein the DC voltage converter is controlled by a cascaded current-voltage controller, and
wherein the adjustable control parameters comprise control parameters of a current controller and/or control parameters of a voltage controller.

21. The controller according to claim 19, wherein the controller is configured to:
calculate a duty cycle loss and/or an additional voltage via the BWHH algorithm using the following input variables:
an input voltage at a primary side of the DC voltage controller;
a duty cycle;
an output voltage at the secondary side of the DC voltage converter; and
an output current at the secondary side of the DC voltage converter.

22. The controller according to claim 21, wherein the controller is configured to:
using the BWHH algorithm and the input variables:
calculate a ripple current;
calculate, from the ripple current, an initial value for a current in a primary side transformer half-unit, or a corresponding stray inductance;
successively calculate, for each phase of a switching scheme of the DC voltage converter, the current; and
at an end of a final phase of the switching scheme, calculate the duty cycle loss and/or the additional voltage therefrom.

23. The controller according to claim 19,
wherein the at least one reference variable corresponds to a reference time delay which is calculated as function of a duty cycle loss, which is calculated using the BWHH algorithm, wherein the reference time delay represents a measure of a delayed switching of the at least one electronic switch on the secondary side.

24. A vehicle comprising:
at least one power-electronics DC voltage converter having a primary side with at least two electronic switches and a secondary side, which is galvanically isolated from the primary side, with at least one electronic switch; and
the controller according to claim 19.

25. The vehicle according to claim 24,
wherein the DC voltage converter is configured to convert a voltage between two on-board electrical energy sub-systems of the vehicle having different voltage levels.

26. The vehicle according to claim 24, wherein the vehicle is an electric vehicle.

27. The vehicle according to claim 24,
wherein the DC voltage converter comprises a primary side having a full-bridge with four electronic switches and a secondary side with two electronic switches, wherein the primary side and the secondary side are galvanically isolated from one another by a transformer.

28. The vehicle according to claim 24, wherein the DC voltage converter is a phase-shifted full-bridge.
